(19) United States
(12) Patent Application Publication
(10) Pub. No.: US 2014/0192909 A1
(43) Pub. Date: Jul. 10, 2014

(54) Apparatus for diversity coupling power line signals into a three-conductor power supply network

(71) Applicant: Patrick Grusdat, Düren (DE)

(72) Inventor: Patrick Grusdat, Düren (DE)

(73) Assignee: devolo AG, Aachen (DE)

(21) Appl. No.: 14/144,851

(22) Filed: Dec. 31, 2013

(30) Foreign Application Priority Data
Jan. 7, 2013 (DE) 10 2013 100 070.3

(51) Int. Cl. H04B 3/56

(52) U.S. Cl. CPC H04B 3/56
USPC 375/258

(57) ABSTRACT

The present invention relates to an apparatus for coupling a modem to a power supply network for transferring data via the power supply network, comprising a power connector, which is configured to connect the apparatus to a phase conductor, a neutral conductor and a protective earth conductor of the power supply network, a transformer, comprising a secondary winding, a first primary winding and a second primary winding connected in series to the first primary winding, wherein the apparatus is configured to couple at least in terms of high frequency a secondary transmission channel to two primary transmission channels.

### CROSS-REFERENCE TO RELATED PATENT APPLICATIONS

This patent application claims priority to German Application No. 102013100070.3, filed Jan. 7, 2013, the entire teachings and disclosure of which are incorporated herein by reference thereto.

### FIELD OF THE INVENTION

The subject matter relates to an apparatus for coupling a modem to a power supply network for transmitting data via the power supply network.

### BACKGROUND OF THE INVENTION

Power line communication (PLC) is a technology which transmits data via energy supply networks. An energy supply network can be the low-voltage installation inside the house as well as the supply network outside the house, or the medium-voltage and high-voltage lines, in the large interconnected power networks of the energy suppliers.

To this end, PLC modulates the data to be transmitted as a high-frequency signal onto the electric lines of the energy supply network. The frequencies used in the course of this lie in the range between 9 kHz and 100 MHz in the current technical implementations, wherein this frequency range can also be widened upwards and/or downwards.

“Diversity” in connection with PLC technology describes the transmission of PLC signals with the aid of further conductors.

The problem with using diversity in PLC technology can be adhering to limit values when certification is carried out. Thus, for example, when certifying according to the standard EN50561-1 (Information technology equipment, communication devices on electrical low-voltage networks—radio interference properties—limit values and measuring methods—Part 1: Devices for use in the home) defined limit values must be adhered to with respect to the transmission level, wherein with PLC diversity processes the transmission level often has to be lowered, in order to adhere to these limit values—accompanied by a loss in the diversity gain.

Taking the previously identified disadvantages as the starting point, the subject matter was based on the object of creating an apparatus for achieving diversity for PLC systems which makes implementation simple and/or makes an improvement in adhering to limit values possible during certification, accompanied by a diversity gain.

### SUMMARY OF THE INVENTION

This object is achieved in terms of the subject matter by an apparatus for coupling a modem to a power supply network for transferring data via the power supply network, comprising a power connector, which is configured to connect the apparatus to a phase conductor, a neutral conductor and a protective earth conductor of the power supply network, a transformer, comprising a secondary winding, a first primary winding and a second primary winding connected in series to the first primary winding, a first primary contact which is arranged on the end of the first primary winding facing away from the second primary winding, a second primary contact which is arranged on the end of the second primary winding facing away from the first primary winding, a third primary contact which is arranged between the first primary winding and the second primary winding, a first and a second secondary contact which are respectively arranged on the different ends of the secondary winding, wherein the first primary contact, the second primary contact and the third primary contact are in each case configured to be connected via the power connector to a different conductor in each case, chosen from a phase conductor, a neutral conductor and a protective earth conductor of the power supply network, and wherein the apparatus is configured to couple at least in terms of high frequency a secondary transmission channel, which is formed between the first and second secondary contacts, to two primary transmission channels, and wherein the apparatus is configured to form a first transmission channel of the two primary transmission channels between the first and the third primary contacts and a second transmission channel of the two primary transmission channels between the second and the third primary contacts.

This object is further achieved in terms of the subject matter by a modem for transmitting data via a power supply network, comprising the previously described apparatus, wherein the modem is attached to the first and second secondary contacts of the apparatus for coupling the modem to the power supply network.

The modem is therefore a PLC modem which is configured for transmitting data via a power supply network.

The apparatus comprises a transformer which comprises a secondary winding, a first primary winding and a second primary winding connected in series to the first primary winding. Hence, the secondary winding is inductively coupled both to the first primary winding and to the second primary winding.

The first primary contact, the second primary contact and the third primary contact of the transformer are in each case configured to be connected via the power connector to a different conductor in each case, chosen from a phase conductor, a neutral conductor and a protective earth conductor of the power supply network, when the power connector is connected to the power supply network, such as by plugging a power plug into a power socket of the power supply network.

For example, the power connector can have a first contact, which is connected to the first primary contact, and a second contact, which is connected to the second primary contact, and a third contact which is connected to the third primary contact, wherein the first contact, the second contact and the third contact of the power connector are connected to a different conductor in each case, chosen from a phase conductor, a neutral conductor and a protective earth conductor of the power supply network, when the power connector is attached to the power supply network. For example, the connector can be a power plug or can be connected to a power plug.

A PLC modem for coupling and/or decoupling PLC signals can, for example, be attached to the first and second secondary contacts of the transformer.

The apparatus is configured to couple at least in terms of high frequency a secondary transmission channel, which is formed between the first secondary contact and the second secondary contact, and to which, for example, a PLC modem can be attached, to two primary transmission channels, wherein a first transmission channel of the two primary transmission channels is formed between the first primary contact and the third primary contact and a second transmission channel of the two primary transmission channels is formed between the second primary contact and the third primary contact.

Frequencies, of more than 1 kHz or more than 9 kHz or more than 100 kHz or more than 1 MHz, for example, can be regarded as high frequency in connection with a PLC transmission. In addition, for example, optionally lower frequency components can also be coupled between the secondary transmission channel and the first primary transmission channel and between the secondary transmission channel and the second primary transmission channel.

Therefore, by way of example, no electrical components acting as a low-pass filter, such as a coil, are arranged between the first primary contact and the first contact of the power connector, between the second primary contact and the second contact of the power connector and between the third primary contact and the third contact of the power connector.

However, by way of example, a capacitor, which can, for example, have a capacitance of 4.7 Nf or a capacitance deviating from this, can be arranged between the first primary contact and the first contact of the power connector and/or between the second primary contact and the second contact of the power connector and/or between the third primary contact and the third contact of the power connector respectively.

Consequently, for example, a PLC modem attached to the first and second secondary contacts can feed a PLC signal into the secondary transmission channel, wherein this signal can be at least partly coupled into both the first primary winding and the second primary winding of the transformer by the secondary winding of the transformer, so that this PLC signal can at least partly be transmitted both via the first primary transmission channel and via the second primary transmission channel.

This coupling variant can therefore, for example, be regarded as a Single-Input Multiple-Output (SIMO) coupling, wherein a diversity gain can be achieved by using the two primary transmission channels.

Conversely, the PLC modem can, for example, receive a PLC signal from the secondary transmission channel, wherein signal components of this PLC signal are received on the primary side both via the first primary transmission channel and via the second primary transmission channel and the transformer couples the first primary transmission channel into the secondary winding through the first primary winding and couples the second primary transmission channel into the secondary winding through the second primary winding.

This coupling variant can therefore, for example, be regarded as a Multiple-Input Single-Output (MISO) coupling, wherein a diversity gain can be achieved by using the two primary transmission channels.

The PLC modem is coupled to the apparatus for transmitting data via the power supply network on the secondary side of the transformer, for example exclusively via the first and second secondary contacts, so that a PLC modem attached to the apparatus for example exclusively uses the secondary transmission channel for feeding PLC signals into the apparatus and/or exclusively uses the secondary transmission channel for receiving PLC signals from the apparatus.

A diversity gain can be simply achieved by using the two primary transmission channels with the coupling variant described by the apparatus for coupling a PLC modem to a power supply network for transmitting data via the power supply network. Here, conventional PLC modems, for example, which are not designed for a Multiple-Input Multiple-Output (MIMO) transmission, can be used by the apparatus for transmitting PLC signals via the two primary transmission channels via the power supply network, accompanied by a diversity gain.

Thus, for example, in half-duplex mode the secondary transmission channel can be used alternately either for sending PLC signals from the modem or for receiving PLC signals at the modem.

According to one advantageous exemplary embodiment, it is proposed that the winding ratio between the first primary winding and the second primary winding is approximately 1:1.

According to one advantageous exemplary embodiment, it is proposed that the winding ratio between the first primary winding and the secondary winding is approximately between 1:1 and 1:2 and that the winding ratio between the second primary winding and the secondary winding is approximately between 1:1 and 1:2.

Hence, for example, the winding ratio between the first primary winding, the second primary winding and the secondary winding can be approximately between 1:1:1 and 1:1:2.

The term “approximately” can be understood in the following, for example, such that a deviation of less than 35% from the nominal value or less than 10% from the nominal value or less than 5% from the nominal value or less than 1% from the nominal value can be understood as approximately corresponding to the nominal value. In the case of a deviation of less than 10%, for example, with an approximate ratio of 1:1, winding ratios between 0.9:1.1 and 1.1:0.9 would come under the approximate ratio of 1:1.

According to one advantageous exemplary embodiment, it is proposed that the winding ratio between the first primary winding and the secondary winding and the winding ratio between the second primary winding and the secondary winding in each case is one of the following ratios: approximately 1:1; and approximately 1:2.

If, for example, the winding ratio between the first primary winding, the second primary winding and the secondary winding is approximately 1:1:2, i.e. the winding ratio between the first primary winding and the secondary winding and the ratio between the second primary winding and the secondary winding is approximately 1:2, then one half of a voltage fed into the secondary transmission channel is coupled into the first primary transmission channel and the other half of the voltage fed in is coupled into the second primary transmission channel.

According to one advantageous exemplary embodiment, it is proposed that the first primary contact is configured to be connected to a conductor chosen from a phase conductor and a neutral conductor and the second primary contact is configured to be connected to the other conductor chosen from a phase conductor and a neutral conductor, and wherein the third primary contact is configured to be connected to the protective earth conductor.

Correspondingly, the second contact of the power connector can be configured such that this second contact is connected to the protective earth conductor (PE) when the power connector is connected to the power supply network, for example by plugging a safety plug with earthing contact into a corresponding power socket of the power supply network.

Furthermore, the first contact of the power connector can be configured to be connected to a conductor chosen from a phase conductor and a neutral conductor of the power supply network and the third contact of the power connector can be configured to be connected to the other conductor chosen from a phase conductor and a neutral conductor of the power supply network when the power connector is attached to the power supply network, such as by plugging a safety plug with earthing contact into a corresponding power socket of the power supply network.

The winding ratio between the first primary winding, the second primary winding and the secondary winding can preferably be approximately 1:1:2, i.e. the winding ratio between the first primary winding and the second primary winding is, for example, approximately 1:1, while the winding ratio between the first primary winding and the secondary winding is, for example, approximately 1:2 or the winding ratio between the second primary winding and the secondary winding is, for example, approximately 1:2.

By choosing, by way of example, the winding ratio of approximately 1:1:2 between the first primary winding, the second primary winding and the secondary winding, one half of a voltage fed into the secondary transmission channel can be coupled into the first primary transmission channel and the other half of the voltage fed in can be coupled into the second primary transmission channel. Here, the ratio of transmission to the phase conductor—neutral conductor path, just like a non-diversity apparatus, is 1:1, whereby nothing changes at the signal level.

Through the third primary contact of the transformer, a centre tap of the two primary windings on PE takes place via the second contact of the power connector, wherein in each case half of the signal voltage is coupled onto PE.

Hence, according to this exemplary embodiment, the transformer has full symmetry with respect to coupling and decoupling PLC signals between the secondary transmission channel and the first and second primary transmission channels.

This type of coupling can then, for example, be particularly advantageous if the power connector comprises, for example, a safety plug with earthing contact which is not specific with regard to the contacting of phase conductor and neutral conductor, such as a plug compatible with CEE (“Commission on the Rules for the Approval of Electrical Equipment”) 7/4, since this type of coupling is independent of whether the first contact of the power connector is connected to the phase conductor or the neutral conductor and the third contact of the power connector is connected to the neutral conductor or the phase conductor, since in both cases full symmetry is ensured. Other plugs with three contacts which are not compatible with CEE 7/4 can also, for instance, be used. As an example, a plug compatible with one selected of NEMA 5 (e.g. NEMA 5-15, or 5-20, or 5-30 or 5-50), NEMA 6 (e.g. NEMA 6-15, or 6-20, or 6-30, or 6-50), NEMA 10 (e.g. NEMA 10-30, or 10-50), NEMA 14 (e.g. NEMA 14-20, or 14-30, or 14-50), NEMA TT-30, NEMA ML-2, NEMA L5, NEMA L6, NEMA L7, NEMA L9, NEMA L14, NEMA L15, NEMA L16, NEMA L17, NEMA L18, NEMA L21, NEMA L22 and NEMA L23 (NEMA—US “National Electrical Manufacturers Association”) may be used. It has to be understood that other NEMA compatible plugs may also be used.

Furthermore, no increase in interference emissions occurs, since the signal level remains unchanged. Therefore, the limit values defined in EN50561-1 (Information technology equipment, communication devices on electrical low-voltage networks—radio interference properties—limit values and measuring methods—Part 1: Devices for use in the home), for example, can be adhered to with respect to the signal level, although a diversity gain is achieved.

Since this type of coupling is independent of the plug-in position of the power plug, there is no worst case with this coupling type, i.e. a certain plug-in position of a power plug, in which the interference emission is at a maximum and would exceed a limit value, which would require the transmitting power to be lowered. Thus, with this type of coupling according to the apparatus corresponding to this exemplary embodiment, a lowering of the transmitting power in order to adhere to limit values can be avoided.

According to one advantageous exemplary embodiment, it is proposed that the second primary winding and the secondary winding have opposite winding directions.

According to one advantageous exemplary embodiment, it is proposed that the first primary winding and the secondary winding have one of the following winding directions: an opposite winding direction and an identical winding direction.

According to one advantageous exemplary embodiment, it is proposed that the first primary contact is configured to be connected to a conductor chosen from a phase conductor and a neutral conductor and the third primary contact is configured to be connected to the other conductor chosen from a phase conductor and a neutral conductor, and wherein the second primary contact is configured to be connected to the protective earth conductor.

Correspondingly, the second contact of the power connector is configured such that this second contact is connected to the protective earth conductor (PE) of the power supply network when the power connector is connected to the power supply network, for example by plugging a safety plug with earthing contact into a corresponding power socket of the power supply network.

In addition, the first contact of the power connector can be configured to be connected to a conductor chosen from a phase conductor and a neutral conductor of the power supply network and the third contact of the power connector can be configured to be connected to the other conductor chosen from a phase conductor and a neutral conductor of the power supply network when the power connector is attached to the power supply network, such as by plugging a safety plug with earthing contact into a corresponding power socket of the power supply network.

With this exemplary embodiment, the winding ratio between the first primary winding, the second primary winding and the secondary winding can, for example, be approximately 1:1:1, i.e. the winding ratio between the first primary winding and the second primary winding is, for example, approximately 1:1, while the winding ratio between the first primary winding and the secondary winding is, for example, approximately 1:1 or the winding ratio between the second primary winding and the secondary winding is, for example, approximately 1:1.

By way of example, with the apparatus according to this exemplary embodiment, the second primary winding and the secondary winding can have opposite winding directions.

Furthermore, according to an exemplary first variant, the first primary winding and the secondary winding also have opposite winding directions.

By means of the winding ratio of approximately 1:1:1, the voltage coupled into the first primary transmission channel is approximately identical to the voltage coupled into the second primary transmission channel. A SIMO or MISO coupling for PLC modems can be simply achieved by this coupling variant.

In the following, by way of example, it should be assumed without limitation that the first contact of the power connector is connected to the neutral conductor (N) and the second contact of the power connector is connected to the phase conductor (L) of the power supply network when the power connector is attached to the power supply network, wherein this can also, for example, take place exactly the other way round.

Furthermore, according to a second exemplary variant, the first primary winding and the secondary winding have identical winding directions. The signal voltage coupled in between L and N and the signal voltage coupled in between L and PE are approximately identical. An almost identical signal results between N and PE through the phase position of this coupling, whereby the voltage difference between N and PE is almost zero. A SIMO or MISO coupling for PLC modems can also be simply achieved by this coupling variant.

According to one advantageous exemplary embodiment, it is proposed that the apparatus is configured to carry out the coupling of the modem for transmitting data to the power supply network on the secondary side of the transformer exclusively via the first and the second secondary contacts.

According to one advantageous exemplary embodiment, it is proposed that the power connector comprises a safety plug with earthing contact which is compatible with CEE 7/4.

According to one advantageous exemplary embodiment, it is proposed that the power connector comprises a safety plug with earthing contact which is compatible with a NEMA connector.

As an example, a plug compatible with one selected of NEMA 5 (e.g. NEMA 5-15, or 5-20, or 5-30 or 5-50), NEMA 6 (e.g. NEMA 6-15, or 6-20, or 6-30, or 6-50), NEMA 10 (e.g. NEMA 10-30, or 10-50), NEMA 14 (e.g. NEMA 14-20, or 14-30, or 14-50), NEMA TT-30, NEMA ML-2, NEMA L5, NEMA L6, NEMA L7, NEMA L9, NEMA L14, NEMA L15, NEMA L16, NEMA L17, NEMA L18, NEMA L21, NEMA L22 and NEMA L23 (NEMA—US “National Electrical Manufacturers Association”) may be used. It has to be understood that other NEMA compatible plugs may also be used.

According to one advantageous exemplary embodiment, it is proposed that the coupling of the modem for transmitting data to the power supply network takes place on the secondary side of the transformer exclusively via the first and the second secondary contacts.

This exemplary embodiment can, for example, particularly apply if the transformer only has a single secondary winding.

Hence, the modem attached to the apparatus can exclusively use the secondary transmission channel for feeding PLC signals into the apparatus and/or can exclusively use the secondary transmission channel for receiving PLC signals from the apparatus.

The modem can, for example, be a PLC modem which originally is only configured for a SISO transmission, i.e. only for transmitting via a single channel (such as via two conductors of a power supply network), wherein by means of the coupling according to the invention this single channel of the modem is coupled to the secondary transmission channel of the apparatus.

According to one advantageous exemplary embodiment, it is proposed that the secondary winding of the transformer constitutes a first secondary winding of the transformer and the secondary transmission channel constitutes a first secondary transmission channel and the transformer comprises a second secondary winding and a third and a fourth secondary contact, wherein the third and fourth secondary contacts are respectively arranged on the different ends of the second secondary winding, and wherein the apparatus is configured to couple at least in terms of high frequency a second secondary transmission channel, which is formed between the third and fourth secondary contacts, to the two primary transmission channels, wherein the first secondary transmission channel is configured as the receive channel for the modem and the second secondary transmission channel is configured as the send channel for the modem.

Both the first secondary winding and the second secondary winding are inductively coupled to the first and second secondary windings.

Hence, for example, the first secondary transmission channel can be connected to a receiver unit of the modem, wherein the receiver unit of the modem can be connected to the first and second secondary contacts of the transformer for receiving signals, and, for example, the second secondary transmission channel can be connected to a transmitting unit of the modem, wherein the transmitting unit of the modem can be connected to the third and fourth secondary contacts of the transformer for sending signals.

By way of example, receiving via the first secondary transmission channel and sending via the second secondary transmission channel can take place in half-duplex mode, since both the first secondary transmission channel is coupled at least in terms of high frequency via the transformer both to the first and the second primary transmission channels and the second secondary transmission channel is coupled at least in terms of high frequency via the transformer both to the first and the second primary transmission channels.

### BRIEF DESCRIPTION OF THE DRAWINGS

According to one advantageous exemplary embodiment, it is proposed that the winding ratio between the first secondary winding and the second secondary winding is approximately the same.

The invention is explained in more detail below with the aid of drawings illustrating exemplary embodiments.

FIG. 1a shows an exemplary apparatus according to a first exemplary embodiment;

FIG. 1b shows an exemplary apparatus according to a modified first exemplary embodiment;

FIG. 2a shows an exemplary apparatus according to a second exemplary embodiment;

FIG. 2b shows an exemplary phasor diagram for the exemplary apparatus according to the second exemplary embodiment;

FIG. 3a shows an exemplary apparatus according to a third exemplary embodiment;

FIG. 3b shows an exemplary phasor diagram for the exemplary apparatus according to the third exemplary embodiment;

FIG. 4a shows an exemplary apparatus according to a fourth exemplary embodiment and

FIG. 4b shows an exemplary phasor diagram for the exemplary apparatus according to the fourth exemplary embodiment.

### DETAILED DESCRIPTION OF THE INVENTION

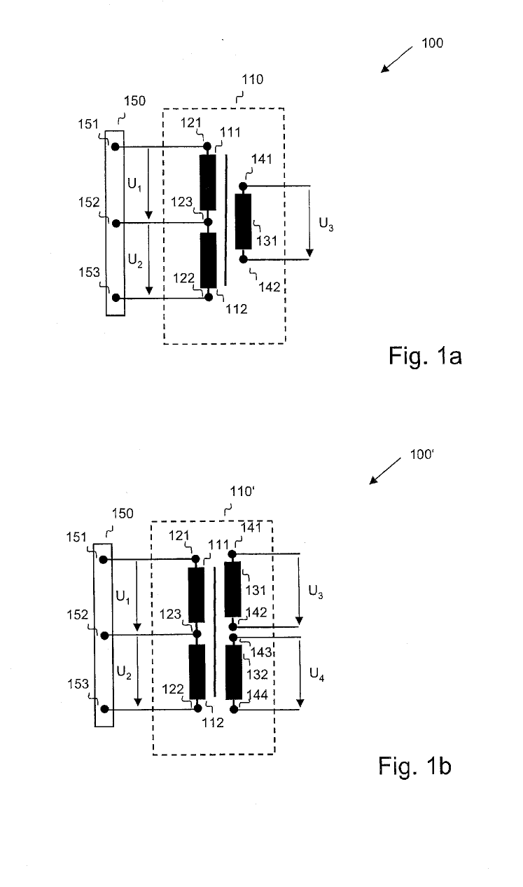

FIG. 1a shows an exemplary apparatus 100 according to a first exemplary embodiment.

The apparatus 100 is configured to couple a PLC modem (not illustrated in FIG. 1) to a power supply network for transmitting data via the power supply network. The apparatus 100 can, for example, constitute part of such a PLC modem.

The apparatus 100 comprises a power connector 150 which is configured to connect the apparatus 100 to a phase conductor, a neutral conductor and a protective earth conductor of the power supply network. The power connector 150 comprises, for example, a first contact 151, a second contact 152 and a third contact 153, wherein in each case one of these three contacts 151, 152, 153 is connected to a different conductor in each case, chosen from a phase conductor, a neutral conductor and a protective earth conductor, when the power connector 150 is connected to the power supply network. The connector 150 can, for example, be a power plug or can be connected to a power plug.

The apparatus 100 comprises a transformer 110 which comprises a secondary winding 131, a first primary winding 111 and a second primary winding 112 connected in series to the first primary winding 111. Hence, the secondary winding 131 is inductively coupled both to the first primary winding 111 and to the second primary winding 112, wherein, for example, a first winding part of the secondary winding 131 is coupled to the first primary winding 111 and a second winding part of the secondary winding 131 is coupled to the second primary winding 112.

The apparatus 100 further comprises a first primary contact 121, which is arranged on the end of the first primary winding 111 facing away from the second primary winding 112, a second primary contact 122, which is arranged on the end of the second primary winding 112 facing away from the first primary winding 111, and a third primary contact 123, which is arranged between the first primary winding 111 and the second primary winding 112. The first primary contact 121, the second primary contact 122 and the third primary contact 123 are in each case configured to be connected via the power connector 150 to a different conductor in each case, chosen from a phase conductor, a neutral conductor and a protective earth conductor of the power supply network, when the power connector 150 is connected to the power supply network, such as by plugging a power plug into a power socket of the power supply network.

In addition, the apparatus 100 comprises a first secondary contact 141 and a second secondary contact 142 which are respectively arranged on the different ends of the secondary winding 131. A PLC modem for coupling and/or decoupling signals can, for example, be attached to these first and second secondary contacts 141, 142.

The apparatus 100 is configured to couple at least in terms of high frequency a secondary transmission channel, which is formed between the first secondary contact 141 and the second secondary contact 142, and to which, for example, a PLC modem can be attached, to two primary transmission channels, wherein a first transmission channel of the two primary transmission channels is formed between the first primary contact 121 and the third primary contact 123 and a second transmission channel of the two primary transmission channels is formed between the second primary contact 122 and the third primary contact 123. Frequencies, for example, of more than 1 kHz or more than 9 kHz or more than 100 kHz or more than 1 MHz can be regarded as high frequency in connection with a PLC transmission. In addition, by way of example, optionally lower frequency components can also be coupled between the secondary transmission channel and the first primary transmission channel and between the secondary transmission channel and the second primary transmission channel.

Therefore, for example, no components acting as a low-pass filter, such as a coil, are arranged between the first primary contact 121 and the first contact 151 of the power connector 150, between the second primary contact 122 and the third contact 153 of the power connector 150 and between the third primary contact 123 and the second contact 152 of the power connector 150. However, preferably, for example, a capacitor, which for instance has a capacitance of 4.7 nF or a capacitance deviating from this (not illustrated in FIG. 1a), can be respectively arranged between the first primary contact 121 and the first contact 151 of the power connector 150 and/or between the second primary contact 122 and the third contact 153 of the power connector 150 and/or between the third primary contact 123 and the second contact 152 of the power connector 150. These capacitors can filter out the 50 Hz power supply voltage.

Hence, a PLC modem attached to the first and second secondary contacts 141, 142, for example, can feed a PLC signal into the secondary transmission channel, wherein this signal can be at least partly coupled through the secondary winding 131 of the transformer 110 both into the first primary winding 111 and the second primary winding 112 of the transformer 110, so that this PLC signal can be at least partly transmitted both via the first primary transmission channel and via the second primary transmission channel. This coupling variant can therefore, for example, be regarded as a Single-Input Multiple-Output (SIMO) coupling, wherein a diversity gain can be achieved by using the two primary transmission channels.

Conversely, the PLC modem can, for example, receive a PLC signal from the secondary transmission channel, wherein signal components of this PLC signal can be received on the primary side both via the first primary transmission channel and via the second primary transmission channel and the transformer couples the first primary transmission channel into the secondary winding 131 through the first primary winding 111 and couples the second primary transmission channel into the secondary winding 131 through the second primary winding 112. This coupling variant can therefore, for example, be regarded as a Multiple-Input Single-Output (MISO) coupling, wherein a diversity gain can be achieved by using the two primary transmission channels.

The PLC modem is coupled to the apparatus 100 for transmitting data via the power supply network on the secondary side of the transformer 110, for example, exclusively via the first and second secondary contacts 141, 142, so that a PLC modem attached to the apparatus 100, for example, exclusively uses the secondary transmission channel for feeding PLC signals into the apparatus 100 and/or exclusively uses the secondary transmission channel for receiving PLC signals from the apparatus 100.

By way of example, in half-duplex mode the secondary transmission channel can be used alternately either for sending PLC signals from the modem or for receiving PLC signals at the modem.

A diversity gain can be simply achieved by using the two primary transmission channels with the coupling variant described by the apparatus 100 for coupling a PLC modem to a power supply network for transmitting data via the power supply network. Here, conventional PLC modems, for example, which are not designed for a Multiple-Input Multiple-Output (MIMO) transmission, can be used by the apparatus 100 for transmitting PLC signals via the two primary transmission channels via the power supply network, accompanied by a diversity gain.

The winding ratio between the first primary winding 111 and the secondary winding 131 and the winding ratio between the second primary winding 112 and the secondary winding 131 can, for example, be approximately between 1:1 and 1:2 and the winding ratio between the first primary winding 111 and the second primary winding 112 can, for example, be approximately 1:1. Hence, for example, the winding ratio between the first primary winding 111, the second primary winding 112 and the secondary winding 131 can be approximately between 1:1:1 and 1:1:2.

The term “approximately” can be understood in the following, for example, such that a deviation of less than 35% from the nominal value or less than 10% from the nominal value or less than 5% from the nominal value or less than 1% from the nominal value can be understood as approximately corresponding to the nominal value. In the case of a deviation of less than 10%, for example, with an approximate winding ratio of 1:1, winding ratios between 0.9:1.1 and 1.1:0.9 would come under the approximate winding ratio of 1:1.

By choosing an approximate winding ratio of 1:1 between the first primary winding 111 and the second primary winding 112, uniform coupling, for example, can be achieved into the first primary transmission channel and into the second primary transmission channel.

The winding ratio between the first primary winding 111 and the secondary winding 131 and the winding ratio between the second primary winding 112 and the secondary winding 131 can, for example, be one of the following ratios: approximately 1:2 and approximately 1:1.

Hence, for example, the winding ratio between the first primary winding 111, the second primary winding 112 and the secondary winding 131 can be approximately 1:1:1 or approximately 1:1:2.

FIG. 1b shows an exemplary apparatus 100′ according to a modified first exemplary embodiment. The apparatus 100′ is based on the apparatus 100 illustrated in FIG. 1a according to the first exemplary embodiment and differs from this apparatus 100 in that the transformer 110′ has, in addition to the secondary winding 131 which can be regarded as the first secondary winding 131, a second secondary winding 132, as well as a third secondary contact 143 and a fourth secondary contact 144.

The apparatus 100′ is configured to couple at least in terms of high frequency a second secondary transmission channel, which is formed between the third secondary contact 143 and the fourth secondary contact 144, to the two primary transmission channels, wherein the first secondary transmission channel is configured as the receive channel for the modem and the second secondary transmission channel is configured as the send channel for the modem (or also vice versa for example).

Both the first secondary winding 131 and the second secondary winding 132 are inductively coupled to the first and second primary windings 111, 112. The second secondary channel is therefore coupled at least in terms of high frequency to the first and secondary primary channels in a similar or identical way as the first secondary channel is coupled at least in terms of high frequency to the first and second primary channels.

Hence, for example, the first secondary transmission channel can be connected to a receiver unit of the modem, wherein the receiver unit of the modem can be connected to the first and second secondary contacts 141, 142 of the transformer 110′ for receiving signals and, for example, the second secondary transmission channel can be connected to a transmitting unit of the modem, wherein the transmitting unit of the modem can be connected to the third and fourth secondary contacts 143, 144 of the transformer 110′ for sending signals.

For example, receiving via the first secondary transmission channel and sending via the second secondary transmission channel can take place in half-duplex mode, since both the first secondary transmission channel is coupled at least in terms of high frequency via the transformer both to the first and the second primary transmission channels and the second secondary transmission channel is coupled at least in terms of high frequency via the transformer both to the first and the second primary transmission channels.

The winding ratio between the first secondary winding and the second secondary winding is, for example, approximately the same. Therefore, the winding ratio between the first primary winding, the second primary winding, the first secondary winding and the second secondary winding can, for example, be approximately between 1:1:1:1 and 1:1:2:2, in particular approximately 1:1:1:1 or approximately 1:1:2:2.

Hence, for example, the first secondary winding 131 can be used for decoupling PLC signals for a receiver of the modem and the second secondary winding 132 can be used for coupling PLC signals produced by a sender of the modem.

Although in the following exemplary embodiments by way of example only the use of a single secondary winding for coupling the modem to the power supply network is described according to the first exemplary embodiment, for each of the following exemplary embodiments on the secondary side of the transformer two secondary windings 131, 132 based on apparatus 100′ of the first exemplary embodiment modified in FIG. 1b can equally be used.

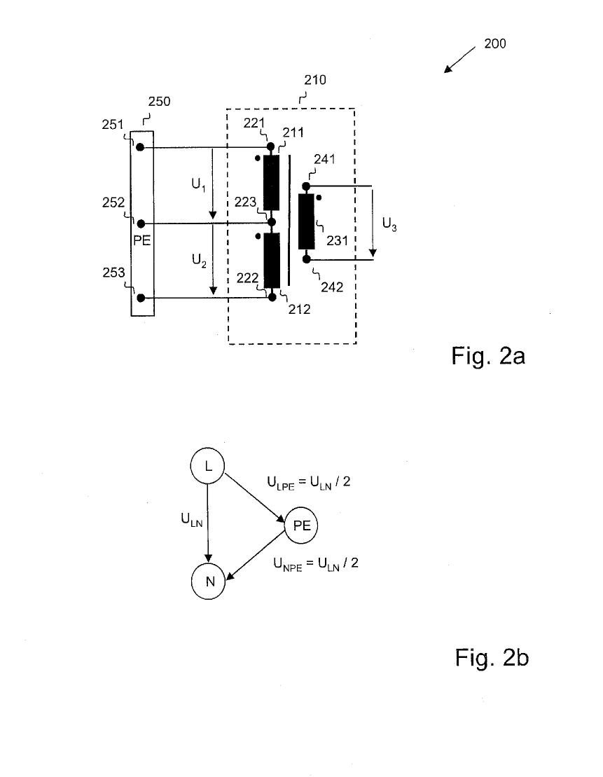

FIG. 2a shows an exemplary apparatus 200 according to a second exemplary embodiment. The apparatus 200 is based on the apparatus 100 illustrated in FIG. 1a according to the first exemplary embodiment or is based on the apparatus 100′ illustrated in FIG. 1b according to the modified first exemplary embodiment. The previously explained details about the apparatus 100 according to the first exemplary embodiment or about the apparatus 100′ according to the modified first exemplary embodiment can therefore equally apply for the apparatus 200 according to the second exemplary embodiment.

In the apparatus 200, the first primary contact 221 is configured to be connected via the first contact 251 of the power connector 250 to a conductor chosen from a phase conductor and a neutral conductor and the second primary contact 222 is configured to be connected via the third contact 253 of the power connector 250 to the other conductor chosen from a phase conductor and a neutral conductor and the third primary contact 223 is configured to be connected via the second contact 252 of the power connector 250 to the protective earth conductor (PE) when the power connector 250 is connected to the power supply network.

Correspondingly, the second contact 252 of the power connector 250 is configured such that this second contact 252 is connected to the protective earth conductor (PE) of the power supply network when the power connector 250 is connected to the power supply network, for example by plugging a safety plug with earthing contact into a corresponding power socket of the power supply network. In addition, the first contact 251 of the power connector 250 is configured to be connected to a conductor chosen from a phase conductor and a neutral conductor of the power supply network and the third contact 253 of the power connector 250 is configured to be connected to the other conductor chosen from a phase conductor and a neutral conductor of the power supply network when the power connector 250 is attached to the power supply network, such as by plugging a safety plug with earthing contact into a corresponding power socket of the power supply network.

The winding ratio between the first primary winding 211, the second primary winding 212 and the secondary winding 231 with the apparatus 200 is, for example, approximately 1:1:2, i.e. the winding ratio between the first primary winding 211 and the second primary winding 212 is, for example, approximately 1:1, while the winding ratio between the first primary winding 211 and the secondary winding 231 is approximately 1:2 or the winding ratio between the second primary winding 212 and the secondary winding 231 is approximately 1:2.

Furthermore, with the apparatus 200 according to the second exemplary embodiment, the first primary winding 211 and the second primary winding 212 have an identical winding direction, wherein the winding direction of the windings 211, 212, 213 in FIG. 2a and in the following figures is represented by a dot at a winding begin of the respective winding. Although the winding direction of the secondary winding in FIG. 2a is denoted by a corresponding dot, the winding direction of the secondary winding 231 can also be opposite to the illustration in FIG. 2a and hence freely selectable, i.e. the winding direction of the secondary winding 231 can, for example, be freely selected. This also applies, for example, for the optional second secondary winding (not illustrated in FIG. 2a) corresponding to the apparatus 100′ from FIG. 1b. Hence, for example, the winding ratio between the first primary winding 111, the second primary winding 112 and the secondary winding 131 can be approximately 1:1:2, so that one half of a voltage |U3| fed into the secondary transmission channel is coupled as voltage |U1| into the first primary transmission channel and the other half of the voltage |U3| fed in is coupled as voltage |U2| into the second primary transmission channel. Here, the ratio of transmission to the phase conductor—neutral conductor path, just like a non-diversity apparatus, is 1:1, whereby nothing changes at the signal level.

Through the third primary contact 223 of the transformer 210, a centre tap of the two primary windings 211, 212 on PE takes place via the second contact 252 of the power connector 250, wherein in each case half of the signal voltage is coupled onto PE.

Hence, the transformer 210 according to apparatus 200 has full symmetry with respect to coupling and decoupling PLC signals between the secondary transmission channel and the first and second primary transmission channels. This type of coupling can then, for example, be particularly advantageous if the power connector 250 comprises a safety plug with earthing contact which is not specific with regard to the contacting of phase conductor and neutral conductor, such as a plug compatible with CEE (“Commission on the Rules for the Approval of Electrical Equipment”) 7/4, since this type of coupling is independent of whether the first contact 251 of the power connector 250 is connected to the phase conductor or the neutral conduct and the third contact 253 of the power connector 250 is connected to the neutral conductor or the phase conductor, since in both cases the full symmetry is ensured. Furthermore, no increase in the interference emissions occurs, since the signal level remains unchanged. Therefore, the limit values defined in EN50561-1 (Information technology equipment, radio interference properties—limit values and measuring methods), for example, can be adhered to with respect to the signal level, although a diversity gain is achieved.

Since this type of coupling is independent of the plug-in position of the power plug, there is no worst case with this coupling type, i.e. a certain plug-in position of a power plug, in which the interference emission is at a maximum and would exceed a limit value, which would require the transmitting power to be lowered. Thus, with this type of coupling according to the apparatus 200 according to the second exemplary embodiment, a lowering of the transmitting power in order to adhere to limit values can be avoided.

Furthermore, as an example, a plug compatible with one selected of NEMA 5 (e.g. NEMA 5-15, or 5-20, or 5-30 or 5-50), NEMA 6 (e.g. NEMA 6-15, or 6-20, or 6-30, or 6-50), NEMA 10 (e.g. NEMA 10-30, or 10-50), NEMA 14 (e.g. NEMA 14-20, or 14-30, or 14-50), NEMA TT-30, NEMA ML-2, NEMA L5, NEMA L6, NEMA L7, NEMA L9, NEMA L14, NEMA L15, NEMA L16, NEMA L17, NEMA L18, NEMA L21, NEMA L22 and NEMA L23 (NEMA—US “National Electrical Manufacturers Association”) may be used. It has to be understood that other NEMA compatible plugs may also be used.

In the following, by way of example, it should be assumed without limitation that the first contact 251 of the power connector 250 is connected to the phase conductor (L) and the third contact 253 of the power connector 250 is connected to the neutral conductor (N) of the power supply network when the power connector 250 is attached to the power supply network, wherein this can also, for example, take place exactly the other way round. For this exemplary assumption, FIG. 2b shows an exemplary phasor diagram for the exemplary apparatus 200 according to the second exemplary embodiment.

The voltage ULN between the phase conductor L and the neutral conductor N is always approximately double the voltage ULPE between L and the protective earth conductor PE and always approximately double the voltage UNPE between PE and N. Hence, the approximately full symmetry can be ensured.

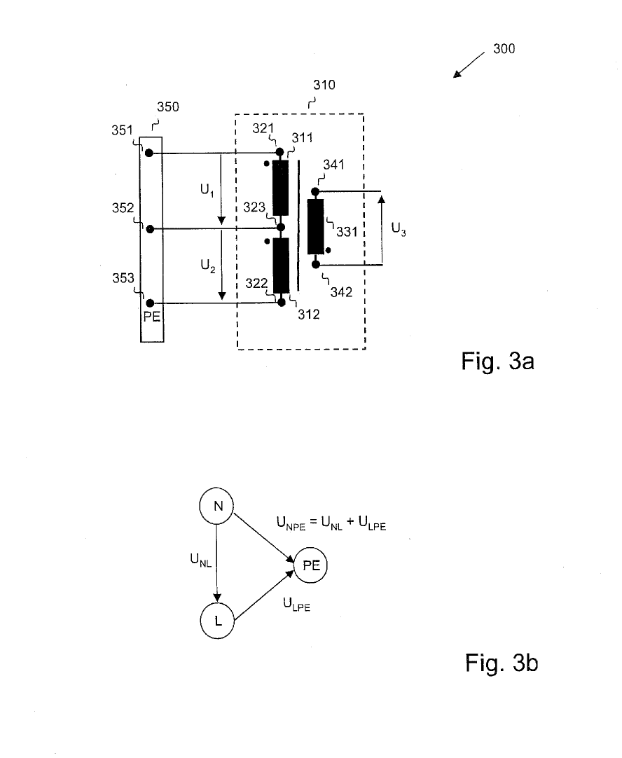

FIG. 3a shows an exemplary apparatus 300 according to a third exemplary embodiment. The apparatus 300 is based on the apparatus 100 illustrated in FIG. 1a according to the first exemplary embodiment or is based on the apparatus 100′ illustrated in FIG. 1b according to the modified first exemplary embodiment. The previously explained details about the apparatus 100 according to the first exemplary embodiment or about the apparatus 100′ according to the modified first exemplary embodiment can therefore equally apply for the apparatus 300 according to the third exemplary embodiment.

In the apparatus 300, the first primary contact 321 is configured to be connected via the first contact 351 of the power connector 350 to a conductor chosen from a phase conductor and a neutral conductor and the third primary contact 323 is configured to be connected via the second contact 352 of the power connector 350 to the other conductor chosen from a phase conductor and a neutral conductor and the second primary contact 322 is configured to be connected via the third contact 353 of the power connector 350 to the protective earth conductor (PE) when the power connector 350 is connected to the power supply network.

Correspondingly, the third contact 353 of the power connector 350 is configured such that this third contact 353 is connected to the protective earth conductor (PE) of the power supply network when the power connector 350 is connected to the power supply network, for example by plugging a safety plug with earthing contact into a corresponding power socket of the power supply network. In addition, the first contact 351 of the power connector 350 is configured to be connected to a conductor chosen from a phase conductor and a neutral conductor of the power supply network and the second contact 352 of the power connector 350 is configured to be connected to the other conductor chosen from a phase conductor and a neutral conductor of the power supply network when the power connector 350 is attached to the power supply network, such as by plugging a safety plug with earthing contact into a corresponding power socket of the power supply network.

The winding ratio between the first primary winding 311, the second primary winding 312 and the secondary winding 331 with the apparatus 300 is, for example, approximately 1:1:1, i.e. the winding ratio between the first primary winding 311 and the second primary winding 312 is, for example, approximately 1:1, while the winding ratio between the first primary winding 311 and the secondary winding 331 is approximately 1:1 or the winding ratio between the second primary winding 312 and the secondary winding 331 is approximately 1:1.

Furthermore, in the case of apparatus 300, the first primary winding 321 has the same winding direction as the second primary winding 312. Although the winding direction of the secondary winding 331 in FIG. 3a is denoted by a corresponding dot, the winding direction of the secondary winding 331 can also be opposite to the illustration in FIG. 3a and hence freely selectable, i.e. the winding direction of the secondary winding 331 can, for example, be freely selected. This also applies, for example, for the optional second secondary winding (not illustrated in FIG. 3a) corresponding to the apparatus 100′ from FIG. 1b.

By means of the winding ratio of approximately 1:1:1, the voltage U1 coupled into the first primary transmission channel is approximately identical to the voltage U2 coupled into the second primary transmission channel.

A SIMO or MISO coupling for PLC modems can be easily achieved by means of this coupling variant. In the following, by way of example, it should be assumed without limitation that the first contact 351 of the power connector 350 is connected to the neutral conductor (N) and the second contact 352 of the power connector 350 is connected to the phase conductor (L) of the power supply network when the power connector 350 is attached to the power supply network, wherein this can also, for example, take place exactly the other way round.

For this exemplary assumption, FIG. 3b shows an exemplary phasor diagram for the exemplary apparatus 300 according to the third exemplary embodiment.

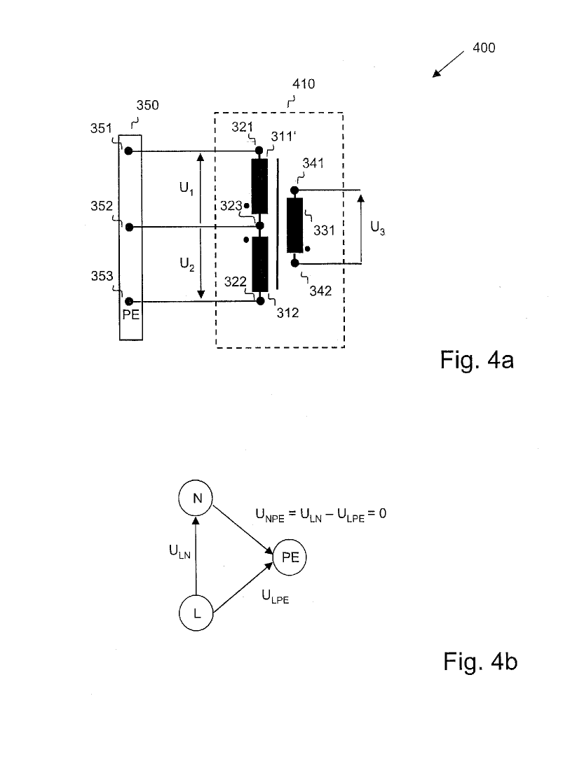

FIG. 4 shows an exemplary apparatus 400 according to a fourth exemplary embodiment, which is based on the apparatus 300 illustrated in FIG. 3a according to the third exemplary embodiment and only differs from this apparatus 300 by the fact that the winding direction of the first primary winding 311′ is opposite to the winding direction of the secondary primary winding 312. As is, by way of example, illustrated in FIG. 4a, both the winding begin of the first primary winding 311′ and the winding begin of the second primary winding 312 can be on the third primary contact 323 (or, conversely, the respective winding ends of the first and second primary windings 311′, 312 can be on the third primary contact 323).

In the following, by way of example, it should be assumed without limitation that the first contact 351 of the power connector 350 is connected to the neutral conductor (N) and the second contact 352 of the power connector 350 is connected to the phase conductor (L) of the power supply network when the power connector 350 is attached to the power supply network, wherein this can also, for example, take place exactly the other way round.

For this exemplary assumption, FIG. 4b shows an exemplary phasor diagram for the exemplary apparatus 400 according to the fourth exemplary embodiment.

The signal voltage U1 coupled in between L and N and the signal voltage U2 coupled in between L and PE are approximately identical. An almost identical signal results between N and PE through the phase position of this coupling, whereby the voltage difference UNPE between N and PE is almost zero.

A SIMO or MISO coupling for PLC modems can be simply achieved by means of this coupling variant.

Generally, the terms first primary winding and second primary winding used in this description are to be understood in relation to the transformer such that the first primary winding and the second primary winding in each case represent different coils or that the first primary winding represents a first winding part of a coil and the second primary winding represents a second winding part of this coil, wherein the third primary contact represents a tap (such as a centre tap) of this coil between the first and second winding parts. Furthermore, the terms “primary” and “secondary”, mentioned in the description, in relation to the transformer can also be interchanged when implementing the transformer.

1. Apparatus for coupling a modem to a power supply network for transferring data via the power supply network, comprising:
a power connector which is configured to connect the apparatus to a phase conductor, a neutral conductor and a protective earth conductor of the power supply network,
a transformer, comprising a secondary winding, a first primary winding and a second primary winding connected in series to the first primary winding,
a first primary contact which is arranged on the end of the first primary winding facing away from the second primary winding,
a second primary contact which is arranged on the end of the second primary winding facing away from the first primary winding,
a third primary contact which is arranged between the first primary winding and the second primary winding,
a first and a second secondary contact which are respectively arranged on the different ends of the secondary winding,
wherein the first primary contact, the second primary contact and the third primary contact are in each case configured to be connected via the power connector to a different conductor in each case, chosen from a phase conductor, a neutral conductor and a protective earth conductor of the power supply network, and
wherein the apparatus is configured to couple at least in terms of high frequency a secondary transmission channel, which is formed between the first and second secondary contacts, to two primary transmission channels, and
wherein the apparatus is configured to form a first transmission channel of the two primary transmission channels between the first and the third primary contacts and a second transmission channel of the two primary transmission channels between the second and the third primary contacts,
wherein the winding ratio between the first primary winding and the second primary winding is approximately 1:1, and the winding ratio between the first primary winding and the secondary winding is approximately 1:2, and the winding ratio between the second primary winding and the secondary winding is approximately 1:2.

2. Apparatus according to claim 1, wherein the first primary winding and the secondary winding have an identical winding direction, and in that the second primary winding and the secondary winding have an identical winding direction.

3. Apparatus according to claim 1, wherein the first primary contact is configured to be connected to a conductor chosen from a phase conductor and a neutral conductor and the second primary contact is configured to be connected to the other conductor chosen from a phase conductor and a neutral conductor, and wherein the third primary contact is configured to be connected to the protective earth conductor.

4. Apparatus according to claim 1, wherein the second primary winding and the secondary winding have opposite winding directions.

5. Apparatus according to claim 4, wherein the first primary winding and the secondary winding have one of the following winding directions:
an opposite winding direction and
an identical winding direction.

6. Apparatus according to claim 1, wherein the first primary contact is configured to be connected to a conductor chosen from a phase conductor and a neutral conductor and the third primary contact is configured to be connected to the other conductor chosen from a phase conductor and a neutral conductor, and wherein the second primary contact is configured to be connected to the protective earth conductor.

7. Apparatus according to claim 1, wherein the apparatus is configured to carry out the coupling of the modem for transmitting data to the power supply network on the secondary side of the transformer exclusively via the first and the second secondary contacts.

8. Apparatus according to claim 1, wherein the power connector comprises a safety plug with earthing contact which is compatible with CEE 7/4.

9. Apparatus according to claim 1, wherein the power connector comprises a safety plug with earthing contact which is compatible with a NEMA connector.

10. Apparatus according to claim 1, wherein the secondary winding of the transformer constitutes a first secondary winding of the transformer and the secondary transmission channel constitutes a first secondary transmission channel and the transformer comprises a second secondary winding and a third and a fourth secondary contact, wherein the third and fourth secondary contacts are respectively arranged on the different ends of the second secondary winding, and wherein the apparatus is configured to couple at least in terms of high frequency a second secondary transmission channel, which is formed between the third and fourth secondary contacts, to the two primary transmission channels, wherein the first secondary transmission channel is configured as the receive channel for the modem and the second secondary transmission channel is configured as the send channel for the modem.

11. Apparatus according to claim 10, wherein the winding ratio between the first secondary winding and the second secondary winding is approximately the same.

12. Modem for transmitting data via a power supply network, comprising an apparatus according to claim 1, wherein the modem is attached to the first and second secondary contacts of the apparatus for coupling the modem to the power supply network.

13. Modem according to claim 12, wherein the coupling of the modem for transmitting data to the power supply network takes place on the secondary side of the transformer exclusively via the first and the second secondary contacts.

14. Modem for transmitting data via a power supply network, comprising an apparatus according to claim 9, wherein the modem is attached to the first and second secondary contacts of the apparatus for coupling the modem to the power supply network for receiving signals at the modem, and wherein the modem is attached to the third and fourth secondary contacts of the apparatus for coupling the modem to the power supply network for sending signals from the modem.
